(19) United States
(12) Patent Application Publication
(10) Pub. No.: US 2025/0214670 A1
(43) Pub. Date: Jul. 3, 2025

(54) Electrically Drivable Tilting Vehicle

(71) Applicant: Bayerische Motoren Werke Aktiengesellschaft, Muenchen (DE)

(72) Inventors: Thomas DEMHARTER, Ostfildern (DE); Martin FROEHLICH, Wolfersdorf (DE); Christian GLUECK, Obertraubling (DE); Philipp HUTTERER, Muenchen (DE); Michael TREFZ, Muenchen (DE)

(21) Appl. No.: 18/848,693

(22) PCT Filed: May 24, 2023
(86) PCT No.: PCT/EP2023/063860

§ 371 Date: Sep. 19, 2024

(30) Foreign Application Priority Data
Jun. 22, 2022 (DE) 10 2022 115 543.9

(51) Int. Cl. B62J 43/16; B62K 11/04; B62K 25/04; B62M 7/02

(52) U.S. Cl. CPC B62J 43/16; B62K 11/04; B62K 25/04; B62M 7/02

(57) ABSTRACT

An electrically drivable tilting vehicle comprises at least one frame carrier structure, on which at least one electric drive means, at least one front wheel guide, at least one suspension strut, and/or at least one swing arm unit of a rear wheel can be fixed. At least one electrical energy storage unit comprises at least one housing which completely encloses a cavity to the outside, and at least one electric storage means arranged in the cavity. The housing comprises at least one load-absorbing frame body which has a cross section in a plane defined by the vertical axis and the longitudinal axis of the tilting vehicle, by way of which cross section the frame body encloses the cavity entirely on the circumferential side, and wherein the load-absorbing frame body of the housing and the frame carrier structure form a common single-piece component at least in sections.

### BACKGROUND AND SUMMARY

This disclosure relates to an electrically drivable tilting vehicle.

The prior art discloses electrically drivable tilting vehicles in which an electrical energy store is provided which supplies electrical energy to an electrical drive. In this case, the electrical energy store units comprise a store housing which forms a closed unit.

Embodiments of the electrically drivable tilting vehicles in which the store housings form a frame carrier structure of the tilting vehicle are known. The known store housings comprise a division of the housing halves in the main flow of the driving-dynamics loads. As a result, the connection between steering and rear wheel guide, which is essential to the driving dynamics, has an insufficient stiffness profile.

In addition, the accessibility of energy store units arranged in the store housing is often not accessible from the outside or only through complete dismantling of the store housing.

Thus, an object of an exemplary embodiment of the disclosure is to propose an electrically drivable tilting vehicle whose suitability for use as an element of the frame carrier structure is improved.

This object is achieved by way of an electrically drivable tilting vehicle comprising at least one frame carrier structure, on which at least one electrical drive means, at least one front wheel guide, at least one suspension strut and/or at least one swing arm unit of a rear wheel can be fixed, and comprising at least one electrical energy store unit comprising at least one store housing, which entirely outwardly encloses a cavity, and at least one electrical store means, which can be or is arranged in the cavity and can supply electrical energy to at least the drive means, wherein the store housing comprises at least one load-supporting frame body which has, in a plane spanned by a vertical axis and a longitudinal axis of the tilting vehicle, a cross section with which the frame body entirely peripherally encloses the cavity and wherein the load-supporting frame body of the store housing of the energy store unit and the frame carrier structure at least partially form a common one-piece component.

Due to the fact that the electrically drivable tilting vehicle comprises an energy store comprising a store housing which comprises a load-supporting frame body which has, in a plane spanned by vertical axis and longitudinal axis of the tilting vehicle, a cross section with which the frame body entirely peripherally encloses the cavity, a support ring is formed which can absorb and transmit a force. This makes it possible to absorb and transmit the main force flow. In addition, the formation of a non-divided frame body improves a stiffness profile.

Due to the fact that the frame body entirely peripherally encloses the cavity, the frame body extends around the cavity in a ring-like or frame-like manner. Due to the fact that the frame body has the closed cross section in the plane through the vertical axis and the longitudinal axis of the tilting vehicle, forces parallel or at an angle to the vertical axis and/or to the longitudinal axis of the tilting vehicle can be absorbed and transmitted by the frame body.

A tilting vehicle is understood to mean bicycles, motorcycles or motor vehicles similar to motorcycles, such as motor scooters, in particular two-wheeled, three-wheeled or four-wheeled motor scooters, scooters, tiltable trikes, quad bikes or the like.

Provision is made in a development of the tilting vehicle for the frame carrier structure to comprise at least one steering head receptacle comprising at least one continuous hollow-cylindrical cutout in which the front wheel guide can be or is fixed in a rotatably mounted manner, wherein the steering head receptacle comprises a separate or separable component which can be fixed on the frame body or wherein the steering head receptacle comprises a portion of the frame body and steering head receptacle and frame body form a common one-piece component.

The steering head receptacle makes it possible to fix the front wheel guide on the frame carrier structure in a rotatably mounted manner. If the steering head receptacle comprises a separate or separable component, this can be releasably or non-releasably fixed on an outer surface of the frame body.

If the steering head receptacle and the frame body form a common one-piece component, assembly effort for the tilting vehicle is reduced.

In addition, provision is made in a development of the tilting vehicle for the frame carrier structure to comprise, in particular on that side of the frame body which lies opposite the steering head receptacle, a receptacle for the suspension strut and/or the swing arm unit of the tilting vehicle, wherein the receptacle for the suspension strut and/or the swing arm unit comprises a separate or separable component which can be fixed on the frame body or wherein the receptacle for the suspension strut and/or the swing arm unit comprises a portion of the frame body and receptacle for the suspension strut and/or the swing arm unit and frame body form a common one-piece component.

If the receptacle for the suspension strut and/or the swing arm unit comprises a separate or separable component, this can be fixed on an outer surface of the frame body.

If the receptacle for the suspension strut and/or the swing arm unit and the frame body form a common one-piece component, the tilting vehicle can be preassembled in a simple manner.

If the frame body, the steering head receptacle and the receptacle for the suspension strut and the swing arm unit form a common one-piece component, this can be produced for example in the production process, for example in the casting process and/or in the injection-molding process.

This makes it possible to reduce the number of individual working steps for production of the tilting vehicle.

In addition, it has proven to be advantageous in a development of the tilting vehicle for the frame carrier structure to comprise a drive receptacle for the drive means of the tilting vehicle, wherein the drive receptacle comprises a separate or separable component which can be fixed on the frame body or wherein the drive receptacle comprises a portion of the frame body and drive receptacle and frame body form a common one-piece component.

In order to increase the stiffness of the frame body, it has proven to be advantageous for the frame body to comprise at least one, in particular rib-like, reinforcing means which extends parallel or at an angle to the plane spanned by vertical axis and longitudinal axis of the tilting vehicle and is arranged on a surface of the frame body facing toward or away from the cavity.

In such a case, the frame body can comprise a single rib-like reinforcing means which extends, for example, from the region of the steering head receptacle as far as the receptacle of the suspension strut and/or of the swing arm unit or the drive receptacle. In addition, multiple reinforcing means running parallel or at an angle to one another can be provided.

In order to be able to arrange at least one electrical energy store unit in the cavity of the store housing or to be able to service or exchange said at least one electrical energy store unit as required, it has proven to be advantageous for the frame body to comprise at least one opening via which the cavity is accessible from a direction at an angle or parallel to the transverse axis and for the store housing to comprise at least one cover element, wherein at least one of the at least one cover element can be fixed on the frame body releasably, in particular by way of a force-fitting, frictional and/or form-fitting engagement, or non-releasably, in particular by way of a force-fitting, frictional, materially bonded or form-fitting engagement, and partially or entirely covers at least one of the at least one opening.

Due to the fact that the frame body comprises at least one opening via which the cavity is accessible from a direction at an angle or parallel to the transverse axis of the tilting vehicle, the at least one electrical energy store unit can be arranged in the cavity in a simple manner. The frame body can, for example, be of pot-like design and comprise the opening only on one side and comprise a closed surface on the side lying opposite the opening.

In addition, embodiments of the frame body in which the opening is of continuous design, that is to say extends from one side of the frame body through the cavity as far as the other side of the frame body, are conceivable. In such a case, the frame body is accessible from both sides.

If at least one of the at least one cover element can be releasably fixed on the frame, the cavity can be closed after the at least one energy store unit has been arranged. This makes it possible to design the store housing in such a way that the cavity is entirely enclosed by frame body and the at least one cover element.

In order to reduce the risk of contaminants or moisture penetrating the cavity, provision is made in a development of the last-mentioned embodiment for the store housing to comprise at least one seal or sealing means which can be or is arranged between the cover element and frame body.

The seal or sealing means is in particular designed to run in encircling fashion and entirely closes a gap that may be present between the cover element and frame body.

In order to make arrangement of the at least one electrical store means easier, in particular in order to be able to ensure arrangement of multiple electrical store means in the cavity in a simple manner, provision is made in an embodiment of the tilting vehicle for the store housing at least one planar base element which is arranged in the cavity and is rotatably or rotationally fixedly fixed on the frame body and on which at least one electrical store means can be arranged and fixed.

In such a case, the at least one store means can be stacked on the at least one planar base element. The planar base element can comprise a plane or can comprise a surface structure or coating which increases the friction between base element and store means.

In addition, embodiments of the tilting vehicle in which multiple base elements are provided, which run parallel or at an angle to one another and are arranged spaced apart from one another in the cavity, are conceivable.

The planar base element can be rotationally fixed on the frame body. In such a case, deformations, in particular transmissions of force, from the frame body to the base element are conceivable. If the base element is rotatably fixed on the frame body, the base element can be decoupled from the frame body with respect to a force flow.

In a development of the last-mentioned embodiment, it has proven to be advantageous for at least one of the at least one base element fixed on the frame body to form a load-supporting stiffening means which can absorb and transmit forces acting on the frame body.

This has in particular proven to be advantageous if the at least one base element is rotationally fixedly fixed on the frame body, that is to say a force flow from the frame body to the base element is enabled. This can increase the stiffness of the store housing.

Finally, it has proven to be advantageous for the frame body, the reinforcing means, the base element and/or the cover element to comprise, entirely or at least in regions, an in particular carbon-fiber-reinforced plastic, in particular a carbon fiber composite plastic/titanium and/or carbon fiber composite plastic/aluminum hybrid structure, and/or a polyaramid, in particular Kevlar.

Further features, details and advantages of the disclosure will emerge from the attached patent claims, from the drawings, and from the following description of a preferred embodiment of the tilting vehicle.

### BRIEF DESCRIPTION OF THE DRAWINGS

FIG. 1 shows an exploded side view of an exemplary embodiment of an electrically drivable tilting vehicle;

FIG. 2 shows a perspective front view of a store housing, without a cover element, of the tilting vehicle according to FIG. 1; and,

FIG. 3 shows a perspective front view of a store housing, with a cover element, of the tilting vehicle according to FIG. 1.

### DETAILED DESCRIPTION OF THE DRAWINGS

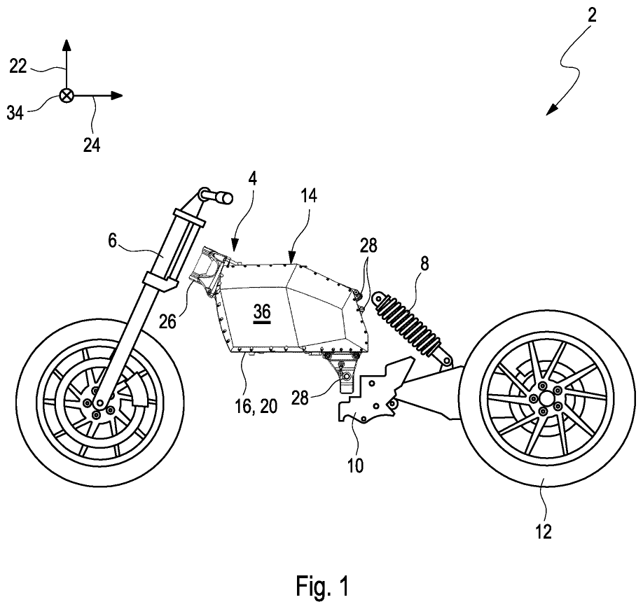

FIG. 1 shows an exploded illustration of an electrically drivable tilting vehicle denoted as a whole by the reference sign 2. The tilting vehicle 2 comprises a frame carrier structure 4 on which at least one electrical drive means (e.g., an electric motor, not illustrated in the figures), at least one front wheel guide 6, at least one suspension strut 8 and/or at least one swing arm unit 10 of a rear wheel 12 can be fixed.

In addition, the tilting vehicle 2 comprises an electrical energy store unit 14 comprising a store housing 16, which entirely outwardly encloses a cavity 18, and at least one electrical store means (e.g., at least one battery or battery module, not illustrated in the figures), which can be or is arranged in the cavity 18. The electrical store means can supply electrical energy to the drive means.

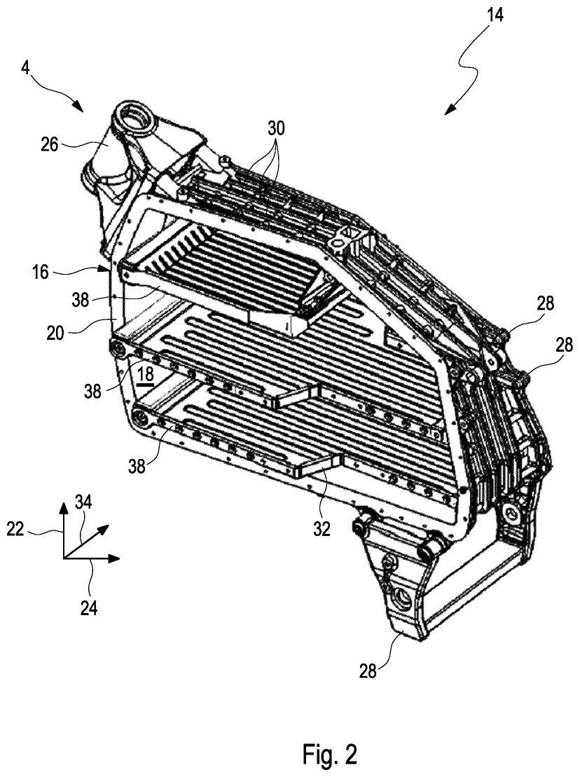

Viewing FIG. 2, it is apparent that the store housing 16 of the energy store unit 14 comprises a load-supporting frame body 20 which has, in a plane spanned by the vertical axis 22 and the longitudinal axis 24 of the tilting vehicle 2, a cross section with which the frame body 20 entirely peripherally encloses the cavity 18. In the exemplary embodiment shown in the figures, the frame body 20 and the frame carrier structure 4 comprise a common one-piece component.

The figures show an exemplary embodiment of the electrically drivable tilting vehicle 2, in which the frame carrier structure 4 comprises a steering head receptacle 26 which is designed as a separate component and is fixed on the frame body 20. By way of the steering head receptacle 26, the front wheel guide 6 is fixed to the frame carrier structure 4 in a rotatably mounted manner.

In addition, the frame carrier structure 4 comprises, on that side of the frame body 20 which lies opposite the steering head receptacle 26, a receptacle 28 for the suspension strut 8 and/or for the swing arm unit 10 of the tilting vehicle 2. The receptacle 28 is also designed as a separable component and fixed on the frame body 20.

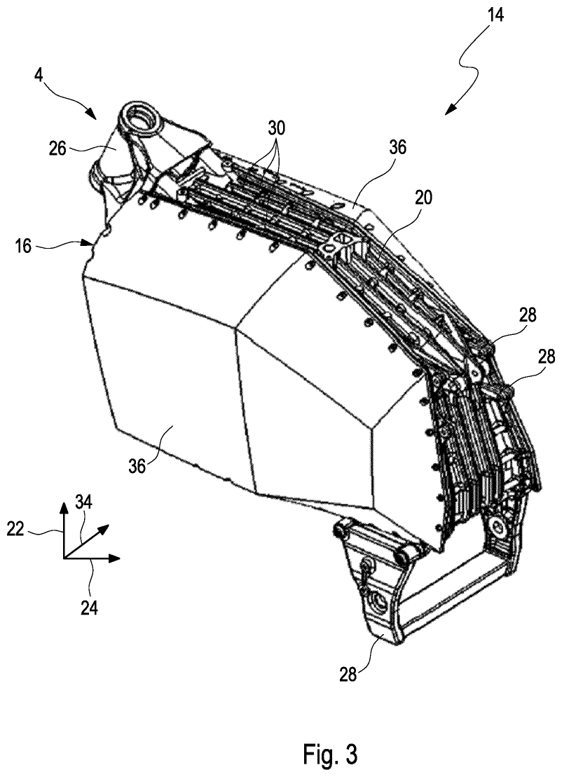

Viewing FIGS. 2 and 3, it is apparent that the store housing 16 comprises multiple ribs or rib-like reinforcing means 30 which extend parallel or at an angle to the plane spanned by vertical axis 22 and longitudinal axis 24 of the tilting vehicle 2 and are arranged on a side of the frame body 20 facing away from the cavity 18.

In the exemplary embodiment shown in the figures, the frame body 20 is designed in such a way that it is accessible from the outside via two openings 32. Viewing FIG. 2, it is apparent that the cavity 18 is accessible, parallel or at an angle to a transverse axis 34 of the tilting vehicle 2, through the opening 32.

In order to entirely surround the cavity 18, in the exemplary embodiment shown in the figures the store housing 16 comprises two cover elements 36 which can be releasably fixed on the frame body 20. The cover elements 36 entirely cover the openings 32.

In addition, in the exemplary embodiment shown in FIG. 2, three base elements 38, which are rotatably fixed on the frame body 20, are arranged in the store housing 16. Store means can be arranged on the base elements 38.

The features of the disclosure which are disclosed in the preceding description, in the claims, and/or in the drawing can be essential, both individually and in any desired combination, to the implementation of the disclosure in its various embodiments as disclosed herein.

### LIST OF REFERENCE SIGNS

2 Tilting vehicle
4 Frame carrier structure
6 Front wheel guide
8 Suspension strut
10 Swing arm unit
12 Rear wheel
14 Energy store unit
16 Store housing
18 Cavity
20 Frame body
22 Vertical axis
24 Longitudinal axis
26 Steering head receptacle
28 Receptacle
30 Reinforcing means
32 Opening
34 Transverse axis
36 Cover element
38 Base element

1.-10. (canceled)

11. An electrically drivable tilting vehicle comprising:
at least one frame carrier structure, on which at least one electric motor, at least one front wheel guide, at least one suspension strut, and/or at least one swing arm unit of a rear wheel can be fixed, and
at least one electrical energy store unit comprising:
at least one store housing defining a cavity, and
at least one battery, which is arranged in the cavity and can supply electrical energy to at least the electric motor,
wherein the store housing comprises at least one load-supporting frame body which has, in a plane spanned by a vertical axis and a longitudinal axis of the tilting vehicle, a cross section with which the frame body entirely peripherally encloses the cavity, and
wherein the load-supporting frame body of the store housing of the energy store unit and the frame carrier structure at least partially form a common one-piece component.

12. The tilting vehicle according to claim 11,
wherein the frame carrier structure comprises at least one steering head receptacle comprising at least one continuous hollow-cylindrical cutout in which the front wheel guide can be or is fixed in a rotatably mounted manner, and
wherein the steering head receptacle comprises a separate or separable component which can be fixed on the frame body, or the steering head receptacle comprises a portion of the frame body and the steering head receptacle and the frame body form a common one-piece component.

13. The tilting vehicle according to claim 11,
wherein the frame carrier structure comprises, on that side of the frame body which lies opposite the steering head receptacle, a receptacle for the suspension strut and/or the swing arm unit of the tilting vehicle, and
wherein the receptacle for the suspension strut and/or the swing arm unit comprises a separate or separable component which can be fixed on the frame body, or the receptacle for the suspension strut and/or the swing arm unit comprises a portion of the frame body and the receptacle for the suspension strut and/or the swing arm unit and the frame body form a common one-piece component.

14. The tilting vehicle according to claim 11,
wherein the frame carrier structure comprises a drive receptacle for the electric motor of the tilting vehicle, and
wherein the drive receptacle comprises a separate or separable component which can be fixed on the frame body, or the drive receptacle comprises a portion of the frame body and drive receptacle and frame body form a common one-piece component.

15. The tilting vehicle according to claim 11,
wherein the frame body comprises at least one rib which extends parallel or at an angle to the plane spanned by vertical the axis and the longitudinal axis of the tilting vehicle and is arranged on a surface of the frame body facing toward or away from the cavity.

16. The tilting vehicle according to claim 11,
wherein the frame body comprises at least one opening via which the cavity is accessible from a direction at an angle or parallel to the transverse axis, and the store housing comprises at least one cover element, and
wherein at least one of the at least one cover element can be fixed on the frame body releasably, by way of a force-fitting, frictional and/or form-fitting engagement, or non-releasably, by way of a force-fitting, frictional, materially bonded or form-fitting engagement, and partially or entirely covers at least one of the at least one opening.

17. The tilting vehicle according to claim 16, wherein the store housing comprises at least one seal arranged between the cover element and the frame body.

18. The tilting vehicle according to claim 11, wherein the store housing comprises at least one planar base element which is arranged in the cavity and is rotatably or rotationally fixed on the frame body and on which at least one battery can be arranged and fixed.

19. The tilting vehicle according to claim 18, wherein at least one of the at least one base element fixed on the frame body constitutes a load-supporting stiffening means which can absorb and transmit forces acting on the frame body.

20. The tilting vehicle according to claim 11, wherein the frame body, the rib, the base element and/or the cover element comprise/comprises, entirely or at least in regions, a carbon-fiber-reinforced plastic and/or a polyaramid.
